(19) United States
(12) Patent Application Publication
(10) Pub. No.: US 2026/0204460 A1
(43) Pub. Date: Jul. 16, 2026

(54) CERAMIC SENSOR WITH METALLIZATION LAYERS

(71) Applicant: TDK Electronics AG, Muenchen (DE)

(72) Inventors: Torben Seifert, Stainz (AT); Sasa Sabeder Daiminger, Maribor (SI); Klaus Rainer, Deutschlandsberg (AT)

(21) Appl. No.: 19/138,431

(22) PCT Filed: Nov. 16, 2023
(86) PCT No.: PCT/EP2023/082052

§ 371 Date: Jun. 12, 2025

(30) Foreign Application Priority Data
Dec. 14, 2022 (DE) 10 2022 133 279.9

(51) Int. Cl. H01C 7/04; G01K 7/22; H01C 1/02; H01C 1/14; H01C 1/142; H01C 17/28

(52) U.S. Cl. CPC H01C 7/041; G01K 7/22; H01C 1/02; H01C 1/1413; H01C 1/142; H01C 7/045; H01C 17/28

(57) ABSTRACT

In an embodiment a sensor includes a ceramic substrate and two metallization layers deposited on opposite surfaces of the ceramic substrate, wherein each of the two metallization layers includes an adhesive layer deposited directly on the ceramic substrate, and wherein each of the two metallization layers comprises a gold layer deposited on a respective adhesive layer.

### CROSS-REFERENCE TO RELATED APPLICATIONS

This patent application is a national phase filing under section 371 of PCT/EP2023/082052, filed Nov. 16, 2023, which claims the priority of German patent application no. 102022133279.9, filed Dec. 14, 2022, each of which is incorporated herein by reference in its entirety.

### TECHNICAL FIELD

The present invention concerns a sensor with a ceramic substrate and metallization layers applied thereto, as well as a method for manufacturing the sensor.

### BACKGROUND

The ever-increasing demands on temperature sensors with regard to higher operating temperatures combined with particularly high reliability and low manufacturing costs require the use of coordinated new material combinations and manufacturing technologies.

Previously available sensors are limited in their operating temperature and can usually only be used up to 300° C.

According to the state of the art, temperatures for monitoring and control in a wide variety of applications are mainly measured using ceramic thermistor elements.

Metallic electrodes must be applied for electrical contacting of the ceramic. According to the state of the art, thick-film metallization is mainly used for this purpose. For example, silver pastes are applied using a screen printing process with subsequent baking. Silver metallization is mainly used for solder connections with connecting wires.

However, the application temperature of soldered joints is limited by the melting temperature of the solder. Solders containing high levels of lead have a melting temperature of approx. 300° C. and most lead-free solders melt at temperatures below 230° C. Soldered joints are not sufficiently reliable when exposed to frequent temperature changes. Many solder materials also tend to migrate in damp or wet environments.

Welding wires onto the electrode of the ceramic is not an alternative, as it causes preliminary damage to the electrode or the ceramic. The wires, which are thicker than the electrode layer thickness, require a very high energy input to melt the wire to make the connection. However, this in turn leads to a complete detachment of the electrode layer from the ceramic and the associated thermal shock can lead to cracks in the ceramic or have a negative impact on the electrical properties.

### SUMMARY

Embodiments provide a sensor and a method for manufacturing the sensor.

Embodiments provide a sensor comprising a ceramic substrate. Metallization layers are applied or deposited on two opposite surfaces of the ceramic substrate. Opposite surfaces are understood here in particular to be surfaces of the substrate which point in opposite or at least approximately opposite directions. Preferably, the two opposing surfaces are two outer surfaces of the ceramic substrate that are minimally spaced apart. The two opposing surfaces can be, for example, a bottom side and a top side of the ceramic substrate or a front side and a rear side of the ceramic substrate.

Each of the two metallization layers comprises a respective adhesive layer applied directly to the ceramic substrate and a respective gold layer applied to the respective adhesive layer. In one embodiment, the metallization layers or one of the metallization layers consist of the respective gold layer and the respective adhesive layer. The respective metallization layer then comprises no further layers in addition to the gold layer and the adhesive layer.

The fact that the adhesive layer is applied directly to the ceramic substrate means that the adhesive layer is in direct contact with the substrate and there are no other layers between the adhesive layer and the ceramic substrate.

The metallization layers can partially or completely cover the two opposing surfaces. Preferably, the adhesive layer has at least the surface area of the gold layer, so that the gold layer is applied completely to the adhesive layer and not directly to the ceramic substrate.

The gold layer is preferably applied directly to the adhesive layer.

In one embodiment, the metallization layers are circular. In further embodiments, the metallization layers are designed as finger electrodes. In one embodiment, the metallization layers cover the entire respective surfaces of the ceramic substrate and are consequently adapted to the shape of the ceramic substrate. Other suitable geometries are also possible.

The adhesive layer can act as a bonding agent between the gold layer and the ceramic layer. The intermediate adhesive layer then improves the adhesion of the gold layer to the ceramic substrate. The adhesive layer creates a stable connection with high pull-off forces between the ceramic substrate and the metallization layer. The sensor is therefore more resistant to mechanical stress with the adhesive layer than without it. The longevity of the sensor is also increased compared to a sensor without an adhesive layer, as premature detachment of the gold layer from the ceramic substrate is avoided.

In one embodiment, the gold layer comprises at least 80 mass percent gold. Furthermore, the gold layer may comprise other metals or metal oxides such as nickel, aluminum, vanadium, chromium or manganese and the oxides of said metals. In further embodiments, the gold layer may comprise at least 90 mass percent gold or consist of gold.

The adhesive layer can preferably be a copper layer. In one embodiment, the copper layer comprises at least 80 percent copper by mass. Furthermore, the adhesive layer may comprise further metals or metal oxides such as nickel, aluminum, vanadium, chromium or manganese and the oxides of said metals. In further embodiments, the copper layer may comprise at least 90 percent copper by mass or consist of copper.

Gold metallization is more stable against chemical reactions than silver metallization. Oxidation or ionization of the gold occurs comparatively rarely. In particular, the selected gold metallization is also stable at high temperatures against migration effects that occur, for example, when silver metallization is used. A short circuit between the two metallization layers can thus be avoided.

Furthermore, a constant electrical behavior of the sensor can be set using the metallization layers described. The electrical parameters of the sensor, such as the electrical resistance at different temperatures, show very little variance in repeated measurements.

In particular, the metallization layers act as electrical contact layers, i.e. as outer electrodes of the ceramic substrate. The ceramic substrate can be contacted at the metallization layers via electrical contact elements such as wires.

According to one embodiment, the ceramic substrate is cuboidal. In particular, this is understood to mean a cuboid with rectangular base and side surfaces.

In this embodiment, the two metallization layers are applied to opposite surfaces of the cuboid ceramic substrate.

A cuboid shape allows simple, for example modular, installation of the ceramic substrate in the sensor. A cuboid shape is also easy to manufacture and therefore inexpensive to produce.

According to one embodiment, the ceramic substrate comprises a thermistor ceramic. The thermistor ceramic can be a thermistor ceramic with a positive temperature coefficient (PTC), i.e. a PTC thermistor, or a thermistor ceramic with a negative temperature coefficient (NTC), i.e. a thermistor.

Alternatively, the ceramic substrate can comprise a varistor, for example.

Preferably, the thermistor ceramic is an NTC ceramic.

The use of a thermistor ceramic, and in particular an NTC ceramic, enables the electrical measurement of an ambient temperature by the sensor.

The use of an NTC ceramic is particularly suitable for detecting high temperatures with the sensor and converting them into corresponding electrical signals.

A sensor comprising an NTC ceramic as a ceramic substrate and the metallization layers as defined above, which comprise adhesive layers, for example copper layers, and gold layers, is suitable for use at high temperatures. The sensor also exhibits unrestricted functionality at high temperatures.

According to one embodiment, the ceramic substrate comprises a ceramic with a perovskite structure.

The ceramic with perovskite structure is suitable for adjusting the thermally conductive properties of the ceramic substrate.

The ceramic with perovskite structure also has a high temperature resistance, which allows the ceramic substrate to be used at high temperatures.

According to a further embodiment, the ceramic of the ceramic substrate may also have a different structure, for example a spinel structure. In particular, a spinel structure can also serve to provide a ceramic substrate with thermally conductive properties.

According to one embodiment, the metallization layers are sputtered. In particular, the adhesive layers and the gold layers are each sputtered. For this purpose, the adhesive layer is preferably sputtered in a first step during the manufacture of the sensor and the gold layer is sputtered on to the adhesive layer in a second step.

A sputtered layer can be significantly thinner than a layer applied by (screen) printing, for example. This saves material and reduces the cost of manufacturing the sensor. Furthermore, the production of the sensor is more resource-efficient and environmentally friendly.

A sputtered layer also has an increased surface wetting compared to a layer applied by screen printing, for example. This means that the metallization layers applied by sputtering completely or almost completely cover the surface of the ceramic substrate without holes appearing in the layer where the ceramic substrate is not covered by the metallization layer.

The advantageous structure of the sputter layer also leads to a low variance in the electrical properties of the sensor. For example, the electrical resistance of the metallization layer hardly changes at different temperatures and in repeated measurements.

In particular, for example, the resistance R₂₅ at room temperature (25° C.), the resistance R₁₀₀ at 100° C. and the B value B are approximately constant. In particular, the coefficient of variation in relation to the resistance R₂₅ or to the resistance R₁₀₀ is at maximum 1.0; preferably at maximum 0.9.

The coefficient of variation in relation to the B value is preferably a maximum of 0.1.

The coefficient of variation is defined as the ratio of the standard deviation to the mean value of a measurement series.

The B value B of a thermistor is defined as follows:

$$B = 1483 , 4 ln ( \frac{{R}_{25}}{{R}_{100}} )$$

According to one embodiment, the adhesive layer has a maximum thickness of 200 nm. Preferably, the layer thickness is a maximum of 100 nm. Such a low layer thickness can be achieved in particular by sputtering.

The adhesive layer is preferably a thin layer.

This layer thickness is already sufficient to ensure adequate adhesion of the metallization layer to the ceramic substrate.

The layer thickness mentioned is still sufficient to obtain complete surface wetting on the surface of the ceramic substrate, i.e. wetting without holes in the metallization layer.

Material can be saved by applying the layer thinly.

According to one embodiment, the gold layer has a maximum thickness of 1000 nm.

Preferably, the layer thickness is a maximum of 500 nm. Such a low layer thickness can be achieved in particular by sputtering.

The gold layer is preferably a thin layer.

This layer thickness is already sufficient to ensure that the metallization layer functions as an electrical contact layer, i.e. as the outer electrode of the sensor.

This layer thickness is still sufficient to achieve complete surface wetting, i.e. wetting without holes in the metallization layer.

Material can be saved by applying the layer thinly.

According to one embodiment, the sensor is a temperature sensor. In this case, embodiments in which the ceramic substrate comprises or consists of a thermistor ceramic, in particular an NTC ceramic, are relevant.

According to one embodiment, the sensor has unrestricted functionality at temperatures up to 600° C. In particular, the sensor has unrestricted electrical functionality at these temperatures. This means that the functionality of the sensor is not impaired by the increased temperatures.

In particular, as described above, this requires a suitable choice of material for the ceramic substrate and for the metallization layers as well as a suitable structure of the ceramic material and the metallization layer, in particular by selecting a suitable application process for the metallization layer.

When choosing a ceramic substrate with a spinel structure instead of a perovskite structure, the sensor exhibits constant functionality, at least at temperatures up to 300° C.

According to one embodiment, the sensor further comprises electrical contact elements such as wires. The electrical contact elements, such as the wires, are applied directly to the metallization layers for electrical contacting. In particular, the electrical contact elements or the wires are connected directly to the surface of the metallization layers, in particular the gold layers. The metallization layer adjoins or at least partially surrounds the wires.

According to one embodiment, the electrical contact elements or the wires are sintered with the metallization layers. This means that a closed connection between the wires and the metallization layers has been produced by sintering the metallization layers and a metallization paste enclosing the ends of the wires in a common step.

For example, the wires are dipped in a gold paste containing gold metal. The paste-wetted surfaces of the wires are then pressed onto the metallization layers. The sensor with the pressed-on wires is placed in an oven and subjected to a thermal profile so that the metallization layer is sintered together with the wire.

In particular, the wires can be nickel alloy wires that are resistant to high temperatures. For example, they can be wires made of nickel-chromium alloys, in particular Inconel® wires, which are particularly temperature-resistant and thus enable the sensor to be used even at high temperatures.

Alternatively, however, any other suitable materials can be used for the wires, for example copper or nickel.

The wires contact the sensor with electronics that can be used to control the ceramic substrate and/or process and evaluate electrical signals from the sensor.

According to one embodiment, the sensor further comprises a glass encapsulation.

According to one embodiment, the ceramic substrate and the metallization layers are surrounded by the glass encapsulation.

Preferably, the ceramic substrate and the metallization layers are completely surrounded, i.e. encapsulated, by the glass encapsulation. Preferably, the end pieces of the electrical contact elements, for example the wires, which are connected to the metallization layers, are also surrounded or encapsulated by the glass encapsulation.

The glass encapsulation protects the sensor from environmental influences and thus prevents the surface of the ceramic substrate, the metallization layers or the wire ends from being altered by corrosion, for example.

Furthermore, the glass encapsulation provides electrical insulation of the sensor from the environment.

In addition, the glass encapsulation is stable even at high temperatures of up to 600° C.

The glass encapsulation can be provided, for example, by means of a preform glass body, i.e. a preformed glass body, for example in the form of a glass cylinder, which is placed over the remaining sensor and then formed, or by immersing the remaining sensor in a glass paste. In particular, the remaining sensor can comprise the ceramic substrate, the metallization layers and the ends of the wires.

A glass coating formed in this way can be subjected to subsequent heat treatment in order to achieve a hermetically sealed encapsulation.

Furthermore, embodiments provide a method of manufacturing a sensor. In particular, the sensor can be designed as described above. All of the aforementioned features and embodiments can also apply to the method.

In the first step of the process, an adhesive layer, e.g. a copper layer, is applied to two opposing surfaces of a ceramic substrate.

In a second step, two gold layers are applied to the respective adhesive layers. This means that one gold layer is applied to each of the adhesive layers.

By applying the different metal layers, i.e. the adhesive layer and the gold layer, in different steps, the described layer sequence is ensured. For this purpose, the second step is preferably carried out after the first step has already been completed.

The gold layer is not in direct contact with the ceramic substrate, but rather the adhesion of the gold layer to the ceramic substrate is improved by an adhesive layer arranged in between as an adhesion promoter.

Both layers can be applied in the same production unit and, for example, by the same sputtering device.

According to one embodiment of the process, the layers are applied by sputtering.

### BRIEF DESCRIPTION OF THE DRAWINGS

In the following, the invention is described in more detail with reference to embodiments and associated figures. The invention is not limited to the embodiments shown in the figures.

FIG. 1 shows a first embodiment of the sensor in cross-section;

FIG. 2 shows an embodiment of the sensor, which further comprises wires for electrical contacting and a glass encapsulation. The glass encapsulation is shown transparent for illustrative purposes; and

FIG. 3 shows another embodiment of the sensor, comprising wires for electrical contacting, during the manufacturing process. A glass cylinder is arranged around the other components of the sensor.

Similar or apparently identical elements in the figures are with the same reference sign. The figures and the proportions in the figures are not necessarily to scale.

### DETAILED DESCRIPTION OF ILLUSTRATIVE EMBODIMENTS

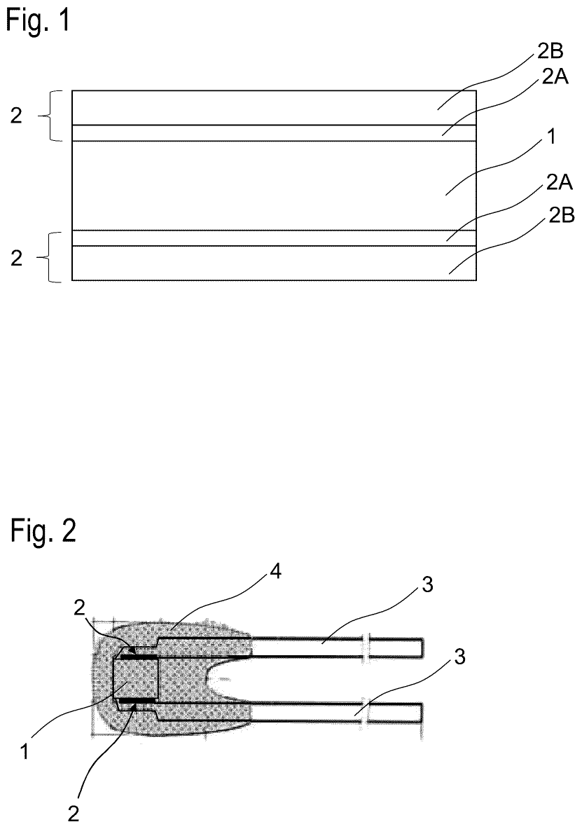

FIG. 1 shows a first embodiment of the sensor. In particular, the sensor comprises a ceramic substrate 1.

The ceramic substrate 1 preferably comprises a thermistor ceramic. The thermistor ceramic is, for example, an NTC ceramic with a negative temperature coefficient, i.e. a thermistor ceramic.

The ceramic substrate 1 preferably comprises a ceramic having a perovskite structure.

The ceramic substrate 1 comprises, for example, a drift-stable perovskite ceramic. In particular, the ceramic substrate 1 may comprise a ceramic material of the general formula [SE₁₋ₓM^{II}x][Cr_{1-y-z}R_{y}L_{z}]O₃, wherein SE stands for one or more rare earth metals, M^{II} stands for one or more metals of oxidation state+II, L stands for Al and/or Ga, R stands for one or more metals selected from Fe, Zn, Ge, Sn, and wherein preferably: 0<x<1; 0<y<1; 0.5<z<1; y+Z<1; 0.1<1−y−z<0.2.

In the embodiment example, the ceramic substrate 1 is cuboid in shape. The cuboid ceramic substrate has 6 outer surfaces. The surfaces have a rectangular shape.

Two metallization layers 2 are applied to two opposite surfaces of the ceramic substrate 1, for example to a front side and a back side or to a bottom side and a top side.

For example, a metallization layer 2 is applied to the underside and a metallization layer 2 is applied to the top side of the substrate 1.

For example, the metallization layer 2 covers the entire surface of the ceramic substrate 1 to which it is applied. Alternatively, the metallization layers 2 are circular, for example.

Alternatively, the metallization layer 2 can also cover only a section of the corresponding surface of the ceramic substrate 1.

Both metallization layers 2 comprise an adhesive layer 2A, in particular a copper layer, and a gold layer 2B.

The adhesive layer 2A is applied directly to the surface of the ceramic substrate 1. Preferably, the adhesive layer 2A, e.g. the copper layer, is sputtered on. No further layers are provided between the adhesive layer 2A and the ceramic substrate 1. The adhesive layer has a high adhesion to the ceramic substrate 1.

A gold layer 2B is applied to each of the surfaces of the adhesive layers 2A facing away from the ceramic substrate 1. The gold layer 2B is preferably applied directly to the adhesive layer 2A, preferably sputtered on.

The adhesive layer 2A can be used as a bonding agent to ensure sufficient adhesion of the gold layer 2B to the ceramic substrate 1 in order to guarantee stable functionality and a long service life of the sensor.

Both layers 2A and 2B are preferably applied by sputtering.

By applying the layers 2 by sputtering, the layers 2 can be thin and made with little material.

For example, the adhesive layer 2A has a layer thickness of no more than 200 nanometers, preferably no more than 100 nanometers. The gold layer 2B, for example, has a layer thickness of no more than 1000 nanometers, preferably no more than 500 nanometers.

These specified layer thicknesses are sufficient to ensure complete wetting of the ceramic substrate 1 by the metallization layers 2. By complete wetting, it is meant in particular that there are no holes in the adhesive layer 2A or in the gold layer 2B that are free of the respective metal.

The metallization layers 2 and in particular the gold layers 2B act as external electrodes, i.e. as electrical contact layers, via which the ceramic substrate 1 can be electrically contacted from the outside. For this purpose, electrical contact elements such as wires 3 are brought into contact with the metallization layers 2.

FIG. 2 shows an embodiment of the sensor, which further comprises wires 3 for electrical contacting and a glass encapsulation 4.

The sensor is also constructed according to the first embodiment. The wires 3 are sintered to the surface of the gold layer 2B.

A contacting paste containing gold and other paste components is provided for this purpose. The other paste components are, in particular, organic additives that modify the plasticity of the paste, for example.

Contact sections of the wires 3, for example their end sections, are dipped into the contacting paste and thus wetted with the contacting paste. Preferably, the entire outer surface of the corresponding wire sections is wetted with the paste. However, the edge length of the sheath surface along the running direction of the wire, which is wetted with the paste, should be shorter than a dimension of the gold layer 2B in the corresponding direction.

The wires 3 with the wetted contact sections are then pressed against the sensor in a suitable mechanical device using mechanical tension and then thermally processed. For this purpose, the mechanical device with the sensor is placed in an oven and subjected to a thermal heating profile. The wires 3 are thus sintered to the surfaces of the gold layers 2B.

Then, as also shown in FIG. 2, the sensor is encased in a glass encapsulation 4.

The glass encapsulation 4 can be produced, for example, according to a first process in which the remaining sensor with the sintered ends of the wires 3 is immersed in a container with glass paste. The remaining sensor thus comprises in particular the ceramic substrate 1, the metallization layers 2 and the ends of the wires 3. The sensors are immersed at a defined speed until the sensor and the wire ends are completely comprised by the glass paste.

To ensure bubble-free encapsulation, the sensors are moved laterally in the glass paste in a defined manner. The sensors are then pulled out of the glass paste again at a defined speed. The defined speed is preferably between 0.1 mm/min (millimeters per minute) and 5 mm/min. For example, the speed is 1 mm/min.

A defined, multi-stage temperature profile is then applied to the sensors coated with glass paste for drying and vitrification.

The drying process must also be carried out with sufficient care to ensure bubble-free and defect-free glass encapsulation and that the additives necessary for the production of the glass paste can escape.

After drying, the glass encapsulation process is carried out, in which the glass coating is brought to a temperature above a glass softening point by means of a defined temperature profile and is thus melted. The hermetically sealed glass encapsulation is formed in the vitrification process.

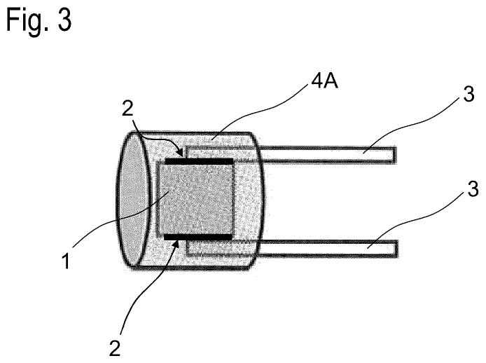

FIG. 3 also shows an alternative procedure for producing the glass encapsulation.

According to the embodiment in FIG. 3, a preformed glass cylinder 4A is positioned around the remaining sensor comprising the ceramic substrate 1, the metallization layers 2 and the ends of the wires 3 sintered thereto.

The sensor with the surrounding glass cylinder 4A is then placed in an oven and the glass cylinder 4A is melted in the oven.

In the case of using a non-pre-sintered glass cylinder, the temperature profile in the oven may again include several stages to vaporize the organic additives that may be contained in the glass cylinder mold.

The molten glass can then be formed into the desired shape in the single-glazing process and then cooled and tempered.

The last method described has the particular advantage that it is particularly cost-effective and can be carried out more easily and quickly.

1.-16. (canceled)

17. A sensor comprising:
a ceramic substrate; and
two metallization layers deposited on opposite surfaces of the ceramic substrate,
wherein each of the two metallization layers comprises an adhesive layer deposited directly on the ceramic substrate, and
wherein each of the two metallization layers comprises a gold layer deposited on a respective adhesive layer.

18. The sensor according to claim 17, wherein the adhesive layer is a copper layer.

19. The sensor according to claim 17, wherein the ceramic substrate comprises a thermistor ceramic.

20. The sensor according to claim 19, wherein the thermistor ceramic is an NTC ceramic.

21. The sensor according to claim 17, wherein the ceramic substrate comprises a ceramic having a perovskite structure.

22. The sensor according to claim 17, wherein the metallization layers are sputtered.

23. The sensor according to claim 17, wherein the adhesive layer has a layer thickness of at most 200 nm.

24. The sensor according to claim 17, wherein the gold layer has a layer thickness of at most 1000 nm.

25. The sensor according to claim 17, wherein the sensor is a temperature sensor.

26. The sensor according to claim 17, wherein the sensor has unrestricted functionality at temperatures up to 600° C.

27. The sensor according to claim 17, further comprising wires configured for electrical contacting, wherein the wires are sintered directly to the gold layers.

28. The sensor according to claim 17, wherein the ceramic substrate and the metallization layers are surrounded by a glass encapsulation.

29. A method for manufacturing a sensor, the method comprising:
applying an adhesive layer to each of two opposing surfaces of a ceramic substrate; and
thereafter, applying two gold layers to respective adhesive layers.

30. The method according to claim 29, wherein the adhesive and the gold layers are applied by sputtering.

31. The method according to claim 29, wherein applying the two gold layers is performed after applying the adhesive has been completed.

32. The method according to claim 29, further comprising, after applying the two gold layer, sintering wires directly to the gold layers, the wires configured for electrical contacting.

33. The method according to claim 29, further comprising forming a glass encapsulation around a remaining sensor.
